(19) United States
(12) Patent Application Publication
(10) Pub. No.: US 2012/0137446 A1
(43) Pub. Date: Jun. 7, 2012

(54) STABILIZATION OF POLYACRYLONITRILE PRECURSOR YARNS

(75) Inventors: Bernd Wohlmann, Dusseldorf (DE); Michael Wolki, Dusseldorf (DE); Christian Hunyar, Wuppertal (DE); Rudolf Emmerich, Kuppenheim (DE); Mathias Kaiser, Karlsbad (DE); Matthias Graf, Pfinztal (Berghausen) (DE); Lukas Alberts, Weinheim (DE); Klaus-Dieter Nauenburg, Hanau (DE)

(73) Assignee: TOHO TENAX EUROPE GMBH, Wuppertal (DE)

(21) Appl. No.: 13/390,635

(22) PCT Filed: Aug. 31, 2010
(86) PCT No.: PCT/EP2010/062674

§ 371 Date: Feb. 15, 2012

(30) Foreign Application Priority Data
Sep. 11, 2009 (EP) 09170059.1

(51) Int. Cl. C08J 7/12

(52) U.S. Cl. 8/115.52

(57) ABSTRACT

A method for stabilizing yarns made from polyacrylonitrile using chemical stabilization reactions, including: generating a field of high-frequency electromagnetic waves in an application space of an applicator, which has areas with minimum electric field strength and areas with maximum electric field strength, the maximum electric field strength in the application space being in a range from 3 to 150 kV/m; continuously supplying a precursor yarn based on a polyacrylonitrile polymer into the application space, and conveying the precursor yarn through the application space and through the field of the high-frequency electromagnetic waves; introducing a process gas into the application space and conveying the process gas through the application space with a flow rate of at least 0.1 m/s relative to the precursor yarn being conveyed through the application space, wherein a temperature of the process gas is in a range between 150 and 300° C., so that it is above a critical minimum temperature T_{crit} and below a maximum temperature Tₘₐₓ.

### BACKGROUND

Stabilized multi-filament yarns made from polyacrylonitrile are required for producing carbon fibers. Today's carbon fibers are made predominantly from polyacrylonitrile fibers, i.e. from polyacrylonitrile precursor yarns. The polyacrylonitrile precursor yarns are thereby initially stabilized by undergoing an oxidation treatment before the stabilized precursor yarns are subsequently carbonized at temperatures of at least 1200° C. in a nitrogen atmosphere, and, if necessary, graphitized in a further step at temperatures up to approximately 2800° C. to achieve carbon fibers therefrom.

Stabilization of polyacrylonitrile precursor yarns is generally understood as the conversion of the yarns, via chemical stabilization reactions, in particular via cyclization reactions and dehydrogenation reactions, from a thermoplastic state into an oxidized, infusible, and, at the same time, flameproof state. Today, the stabilization is normally performed in conventional convection ovens at temperatures between 200 and 300° C. and in an oxygen-containing atmosphere (see e.g. F. Fourné: “Synthetische Fasern”, Carl Hanser Verlag, Munich Vienna, 1995, Chapter 5.7). An gradual conversion of the precursor yarn from a thermoplastic into an oxidized, infusible fiber takes place thereby via an exothermic reaction (J.-B. Donnet, R. C. Bansal: “Carbon Fibers”, Marcel Dekker, Inc., New York and Basel 1984, pages 14-23). The conversion can be visually recognized by a characteristic discoloration of the initially white yarn through yellow to brown and finally to black. The stabilization can also take place in a plurality of steps, through which increasing degrees of stabilization are achieved. At increasing stabilization, the density of the yarn also increases, for example from 1.19 g/cm³ to 1.40 g/cm³, wherein the changes in the density become more pronounced with increasing stabilization.

During the exothermal chemical reactions to convert or stabilize the polyacrylonitrile precursor, so much heat can be generated that it leads to melting or thermal degradation of the yarn. Therefore, in the conventional stabilization process, the yarn is conveyed through differently tempered steps in the oven, by which means a slow heating of the yarn can be adjusted and thus a sufficient dissipation of the exothermal heat from the yarn material can be achieved. In this way, the stabilization can occur for example in a conventional convection oven with three steps, wherein in the first step a residence time of at least 20 min at temperatures in the range from 200 to 300° C. is required as a rule, in order to carry out the stabilization to such an extent that the density of the precursor yarn is increased by approximately 0.03 g/cm³. Similar residence times are required in the remaining steps of the oven, so that in the conventional process, a total residence time of at least approximately one hour is necessary for the stabilization. At the same time, the stabilization requires comparatively slow process speeds, whereby the stabilization becomes the speed-determining process in the continuous production of carbon fibers. At the same time, due to the low process speeds and the necessarily long residence times, which can amount to approximately 2.5 hours depending on the process control, large stabilizing ovens are required. Therefore, there is a desire for methods for stabilizing polyacrylonitrile precursor yarns that enable shorter residence times and/or higher process speeds.

### SUMMARY

It is therefore an object to provide a method for stabilizing yarns made from polyacrylonitrile, in which the disadvantages of the known methods are at least reduced, and which allows the stabilization of polyacrylonitrile precursor yarns for producing carbon fibers at higher process speeds and/or at lower residence times.

The object is achieved by a method for stabilizing yarns made from polyacrylonitrile using chemical stabilization reactions, comprising:
generating a field of high-frequency electromagnetic waves in an application space of an applicator, which has areas with minimum electric field strength and areas with maximum electric field strength, the maximum electric field strength in the application space being in the range from 3 to 150 kV/m,
continuously supplying a precursor yarn based on a polyacrylonitrile polymer into the application space, and conveying the precursor yarn through the application space and through the field of the high-frequency electromagnetic waves, thereby introducing a process gas into the application space and conveying the process gas through the application space with a flow rate of at least 0.1 m/s relative to the precursor yarn being conveyed through the application space, wherein the temperature of the process gas is set in the range between 150 and 300° C., so that it is above the critical minimum temperature T_{crit} and below the maximum temperature Tₘₐₓ, and wherein the critical minimum temperature T_{crit} is that temperature above which the high-frequency electromagnetic waves couple into the precursor yarn being conveyed through the application space and the chemical stabilization reactions proceed, and the maximum temperature Tₘₐₓ is that temperature which lies 20° C. below the decomposition temperature of the precursor yarn being supplied into the application space.

### BRIEF DESCRIPTION OF THE DRAWING

FIG. 1 shows an application device suitable for carrying out a method according to an embodiment of the invention.

### DETAILED DESCRIPTION OF EMBODIMENTS

A method for stabilizing yarns made from polyacrylonitrile using chemical stabilization reactions is provided, comprising: generating a field of high-frequency electromagnetic waves in an application space of an applicator, which has areas with minimum electric field strength and areas with maximum electric field strength, the maximum electric field strength in the application space being in the range from 3 to 150 kV/m; continuously supplying a precursor yarn based on a polyacrylonitrile polymer into the application space, and conveying the precursor yarn through the application space and through the field of the high-frequency electromagnetic waves; and introducing a process gas into the application space and conveying the process gas through the application space with a flow rate of at least 0.1 m/s relative to the precursor yarn being conveyed through the application space, wherein the temperature of the process gas is set in the range between 150 and 300° C., so that it is above the critical minimum temperature T_{crit} and below the maximum temperature Tₘₐₓ, and wherein the critical minimum temperature T_{crit} is that temperature above which the high-frequency electromagnetic waves couple into the precursor yarn being conveyed through the application space and the chemical stabilization reactions proceed, and the maximum temperature Tₘₐₓ is that temperature which lies 20° C. below the decomposition temperature of the precursor yarn being supplied into the application space.

The precursor yarn can be based on a polyacrylonitrile polymer and can be a yarn that contains at least 85% polymerized acrylonitrile. The polyacrylonitrile polymer can also contain parts of comonomers, such as e.g. vinyl acetate, acrylic acid methyl ester, methacrylic acid methyl ester, vinyl chloride, vinylidene chloride, styrene, or itaconic acid (-ester).

The thermoplastic polyacrylonitrile precursor yarn can be a yarn that has not been subjected to any kind of stabilization. In embodiments, the precursor yarn provided can also however be a polyacrylonitrile yarn that has already undergone a partial stabilization, wherein the stabilization is continued. On the other hand, the embodiments are not limited such that the precursor yarn provided is completely stabilized by means of the method, rather it can also be implemented in such a way that the yarn is only stabilized up to a certain degree. The method can thus be suitable for partially or also completely stabilizing an untreated precursor yarn made from polyacrylonitrile. The method likewise can comprise the further partial or the complete stabilization of an already partially stabilized precursor yarn. The previous partial stabilization and/or a downstream completion of the stabilization can thereby likewise occur in embodiments of the method, or also in conventional convection ovens according to known methods.

When performing the method, high-frequency electromagnetic waves are generated, in e.g. a magnetron, which waves are fed into the application space via suitable means, preferably via a wave-guide or a coaxial conductor. The applicator normally has a channel shaped application space with a wall made from a conductive material, which is traversed by the precursor yarn to be stabilized and into which the electromagnetic waves are supplied. The wall surrounding the application space can for example be a continuous metal wall. It is, however, also possible to form the wall from a conductive, grid-shaped material. Preferably, the application space has a circular, oval, or rectangular contour transverse to the conveying direction of the precursor yarn and thus transverse to the propagation direction of the electromagnetic waves. In an especially preferred embodiment, the applicator is a rectangular wave-guide.

In a likewise preferred embodiment, the application space additionally comprises a conductive element in the inner space surrounded by the wall, which conductive element is preferably a metal rod. It is advantageous here if the conductive element extends coaxially to the longitudinal axis of the application space, i.e. in the propagation direction of the electromagnetic waves, by which means a coaxial conductor is formed. It is especially preferred that the conductive element is arranged thereby in the center of the application space. It is advantageous for coaxial conductors of this type if the application space has a circular contour transverse to the propagation direction of the electromagnetic waves.

The application space can have orifices at its inlet end, at which end the precursor yarn enters the applicator, and/or at its outlet end, where the precursor yarn leaves the applicator, through which orifices the precursor yarn is conveyed. The high-frequency electromagnetic waves are retained in the application space by these orifices.

The wave guide, via which the high-frequency electromagnetic waves from e.g. a magnetron are fed into the applicator, can e.g. be a tube that is connected to the application space via an elbow pipe, wherein the precursor yarn to be stabilized is fed in the area of the elbow pipe through the wall into the application space.

In the applicator, i.e. in the application space, the high-frequency electromagnetic waves supplied therein form a field structure, defined by the geometry of the application space, with wave maxima and wave minima, i.e. with areas of maximum electrical field strength and areas with minimal electrical field strength. According to embodiments of the invention, in the application space the maximum electrical field strength of the high-frequency electromagnetic waves is adjusted to a level in the range from 3 to 150 kV/m. The level of the field strength thereby refers to the unloaded state of the applicator, i.e. a state, during which the precursor yarn to be stabilized is not being conveyed through the applicator. In tests, it has proven favorable in view of the conversion reactions proceeding in the precursor yarn during the stabilization, if a maximum electric field strength of the high-frequency electromagnetic waves in the range from 5 to 50 kV/m is generated in the application space. At the same time, it showed that for precursor yarns that have already been partially stabilized, field strengths can be set in the upper range, whereas for yarns that have not been (partially) stabilized, lower field strengths should be set instead to avoid exothermic conversion reactions that are too intense and could lead to destruction of the precursor yarn.

In embodiments, high frequency electromagnetic waves having a frequency from 300 MHz to 300 GHz are preferred, which are generally designated as microwaves. Microwaves in the range from 300 MHz to 45 GHz are particularly preferred and in a particular embodiment, microwaves in the range from 900 MHz to 5.8 GHz. Microwaves with a frequency of 915 MHz and 2.45 GHz are used as a standard, and are most suitable.

In embodiments, it is essential that a process gas is supplied into the application space and flows through this space, and that the temperature of the process gas in the application space is set in the range between 150 and 300° C., so that it is above the critical minimum temperature T_{crit} and below the maximum temperature Tₘₐₓ. The process gas in an embodiment of the method according to the invention can be an inert gas, for example nitrogen, argon, or helium. Nitrogen is preferably used as the inert gas. In a further preferred embodiment, the process gas used in the method according to the invention can be a gas containing oxygen. It has been shown that stabilization by means of a gas containing oxygen can achieve higher carbon yields. Thereby a gas containing oxygen is understood to mean a gas containing molecular oxygen, wherein the concentration of the molecular oxygen in the gas containing oxygen is preferably less than 80 vol. %. More particularly preferred, the gas containing oxygen is air.

The critical minimum temperature T_{crit} is understood to be that temperature, above which the high-frequency electromagnetic waves couple into the precursor yarn being conveyed through the application device to a sufficient degree, i.e. above which temperature the electromagnetic waves are absorbed to a sufficient degree by the yarn, and the conversion reactions take place. Namely, it has been shown that the atmosphere surrounding the precursor yarn in the application space and thus the precursor yarn being conveyed through the application space itself must exceed a certain threshold temperature, i.e. the critical minimum temperature, so that the high-frequency electromagnetic waves couple so strongly into the precursor yarn that the conversion reactions or chemical stabilization reactions, i.e. particularly cyclization reactions, dehydrogenation reactions, and oxidation reactions can proceed to stabilize the yarn. Below the critical minimum temperature, the high-frequency electromagnetic waves can indeed already couple into the yarn, however, the electromagnetic waves that are coupled in do not yet lead to a temperature increase in the yarn sufficient to initiate the conversion reactions, because a cooling of the yarn occurs simultaneously due to the process gas flowing by relative to the yarn.

The critical minimum temperature T_{crit} can thereby be determined in a simple manner for each precursor yarn being conveyed through the application device. As stated, above the critical minimum temperature, the precursor yarn absorbs the electromagnetic waves to a sufficient degree; the resulting temperature increase in the yarn initiates the conversion reactions leading to the stabilization of the yarn. As a result, HCN gas is released among others. The HCN gas can be measured by means of usual analysis methods, such as e.g. using gas chromatography, mass spectroscopy or by means of electrochemical HCN sensors in the gas outlet, via which the process gas supplied to the applicator is discharged from the applicator. The minimum temperature is thus understood as that temperature above which the electromagnetic waves are so strongly coupled into or so strongly absorbed by the yarn that the conversion reactions, i.e. in particular the cyclization reactions, occur in the yarn, as a result of which HCN gas is released. Alternatively, the occurrence of the conversion reactions can be detected via the cyclization associated with the splitting off of the HCN using IR spectroscopy.

The maximum temperature Tₘₐₓ is to be understood as that temperature which lies 20° C. below the decomposition temperature of the yarn being supplied in the application device. For a safe, continuous process control, it is required that the maximum temperatures prevailing in the application space lie sufficiently below the decomposition temperature of the yarn being supplied into the application device. Higher temperatures would lead to an increased risk of decomposition of the yarn and of thread breakages and thus to an interruption of the process. In a preferred embodiment of the method according to the invention, the process gas in the application space has a temperature in the range between (T_{crit}+20° C.) and (Tₘₐₓ−20° C.). The decomposition temperature can be determined in an easy manner using thermogravimetric measurements. The decomposition temperature is thereby that temperature at which a sample of the precursor yarn loses 5% of its mass within a time period of less than 5 minutes.

The corresponding critical minimum temperature T_{crit} as well as the maximum temperature Tₘₐₓ are dependent on the precursor material, i.e. for example on the concrete polyacrylonitrile polymer. The polyacrylonitrile precursor yarns that are usually used for the purpose of producing carbon fibers can be used. The critical minimum temperature as well as the maximum temperature can additionally be influenced by additives added to the polyacrylonitrile. Thus, in an advantageous embodiment the precursor yarn can contain additives that affect an improvement of the absorption capability of the precursor yarn with regard to high-frequency electromagnetic waves. It is especially preferred that these additives be polyethylene glycol, carbon black, or carbon nanotubes.

The critical minimum temperature as well as the maximum temperature are moreover dependent on the degree of stabilization of the precursor yarn supplied. It shows that at increasing degrees of stabilization the critical minimum temperature is shifted to higher values. It likewise shows that an increasing stabilization has an effect in the direction of an increasing thermal stability and resulting therefrom in increasing decomposition temperatures, and therefore also in increasing maximum temperatures.

The adjustment of the temperature of the process gas flowing through the application space can for example be achieved by feeding a gas heated to the required temperature into a thermally insulated application space. Likewise, a process gas initially tempered to a lower temperature level can be heated to the required temperature in the application space or in a heat exchanger upstream of the application space, e.g. by means of suitable heating elements or by means of IR radiation. Naturally, a combination of different methods is also possible to set the required temperature of the process gas in the application space.

During the stabilization of precursor yarns made from polyacrylonitrile, conversion reactions occur, such as e.g. cyclization reactions or dehydrogenation reactions, during which the yarn is converted from a thermoplastic yarn ultimately into a thermally crosslinked yarn and thus into an infusible and at the same time flameproof state. Thereby the previously described characteristic discoloration of the yarn occurs. As they proceed, the conversion reactions show a strongly exothermic enthalpy and as a result of the stabilization, lead to a shrinkage of the yarn as well as to a reduction in weight of the yarn, associated with the formation of volatile decomposition products such as e.g. HCN, NH₃, or H₂O. At the same time, an increase in the density of the precursor yarn occurs. Thus, e.g. for a precursor based on a polyacrylonitrile polymer, it is found that the density of for example originally approximately 1.19 g/cm³ increases due to the stabilization ultimately to a value of up to approximately 1.40 g/cm³. The degree of stabilization can therefore also be determined based on the density of the precursor material.

The process gas supplied into the application space has on the one hand the task of guaranteeing a temperature level at the yarn, at which level a sufficient coupling of the high-frequency electromagnetic waves into the yarn occurs. In addition, the process gas has the task of removing the volatile decomposition products, such as e.g. HCN, NH₃, or H₂O, which are released during the conversion reactions, and also the task of dissipating the reaction heat generated, thus ensuring a temperature level, in particular in the area of the precursor yarn, that lies below the maximum temperature Tₘₐₓ. In the preferred case, in which a gas containing oxygen is used as the process gas, and this gas ultimately also has the task of making available the required amount of oxygen for the conversion and/or oxidation reactions in the precursor yarn that lead to the stabilization. Therefore, in the process according to embodiments, the process gas is fed through the application space so that it has a flow rate of at least 0.1 m/s relative to the precursor yarn being conveyed through the application space. The flow rate is thereby to be adjusted above 0.1 m/s relative to the precursor yarn, so that the above-mentioned requirement is fulfilled. On the other hand, there are upper limits for the flow rate insofar as a gas flow rate that is too high leads to instabilities in the run of the thread of the precursor yarn and there exists thus a risk of thread breakage or breaking of the yarn.

In a preferred embodiment, the process gas is supplied into the application space and discharged therefrom so that the gas flows through the application space vertically to the precursor yarn, wherein the flow rate vertical to the precursor yarn is in the range from 0.1 to 2 m/s. In a further preferred embodiment of the method according to the invention, the process gas is supplied into the application space and discharged therefrom in such a way that the process gas flows parallel to the precursor yarn through the application space in a co-current flow or in a counter-current flow to the transport direction of the precursor yarn, with an average flow rate, in relation to the open cross-section of the application space, of 0.1 to 20 m/s relative to the precursor yarn being conveyed through the application space. It is especially preferred for the flow rate to lie in the range between 0.5 and 5 m/s.

To counteract the shrinkage that occurs during the stabilization and to retain or to achieve an orientation of the polyacrylonitrile molecules, it is required that the precursor yarn is held at a defined tension in the applicator. Preferably the precursor yarn is fed through the applicator at a thread tension in the range from 0.125 to 5 cN/tex. A thread tension in the range from 0.5 to 3.5 cN/tex is especially preferred.

To achieve a sufficient stabilization or partial stabilization on the one hand, while on the other hand to be able to adjust process conditions, concerning e.g. the field strength in the application space, the temperature of the process gas or its flow rate, which enable a stable run of the thread of the precursor yarn and a stable process, the residence time of the precursor yarn in the application space is at least 20 s. An upper limit for the residence time results thereby from e.g. the desired degree of stabilization, which should be achieved after the yarn has been conveyed through the applicator, or also from device-related boundary conditions, such as related to the feasible length of the applicator.

To realize sufficiently long residence times in order to achieve high degrees of stabilization, there is on the one hand the possibility of using a single, correspondingly long applicator. In a preferred embodiment, the precursor yarn is successively conveyed continuously through a plurality, i.e. through at least two application devices arranged in series. Each of these application devices can thereby be equipped with its own means for generating a field of high-frequency electromagnetic waves; it is however also possible that all application devices have e.g. a common microwave generator. In general, the series connection of a plurality of application devices has the advantage, that an independent adjustment with regard to the optimum process parameters can take place in each of the application devices in consideration of e.g. the actual degree of stabilization of the precursor yarn being conveyed through the respective application device, such as e.g. with regard to the field strength, the temperature, the flow rate of the process gas, the percentage of oxygen if the gas used contains oxygen, the residence time, the thread tension, etc.

In the application, the frequency of e.g. the microwaves is technically determined to certain areas by the availability of favorable, high-output sources. At the same time, the field distribution in the application space is determined by its geometry and by the frequency and power of the electromagnetic waves supplied. Thereby, in the application space, field maxima are generated, whose distance is determined by the geometry of the application space, among others.

In a continuous process with sufficient residence times in the application space, the precursor yarn to be stabilized is conveyed through the stationary field maxima in the application space at a rhythm preset by the yarn speed. Thereby, a distinct heating or calefaction of the yarn occurs in the area of the maxima, depending on the average field strength and the temperature of the process gas, and a cooling in the area of the minima due to the process gas flowing against the fibers. At relatively low fiber speeds and in particular for precursor yarns, for which either no or only a very low level of stabilization has occurred, this can lead to the stabilization process entering an unstable range. On the one hand, due to the high intensity of the coupled-in electromagnetic waves in the area of the maxima, the described exothermally proceeding conversion reactions can occur to a great extent, and lead, on their part, to a temperature increase in the yarn material. This, in turn, leads to an improved coupling-in of the electromagnetic waves and therefore to an intensification of the exothermal reactions, associated with an additional increase of the temperature in the yarn. On the other hand, the heat generated can only be discharged to a limited extent via the process gas flowing against the yarn, so that the stabilization process becomes instable. A stabilization of the process can be achieved in such cases for example via a variation of the field strength over time.

In a preferred embodiment, the field strength in the application space therefore has an intensity periodically changing over time, wherein the cycle duration is primarily determined by the yarn speed and by the distance of the stationary field maxima. It is especially preferred if the intensity changes are sinoidal or in the form of pulses, wherein at a pulsed intensity change, the field strength for example can change between two levels different from zero or between zero and a level different from zero.

Embodiments of the invention will be explained in more detail on the basis of the following FIGURE as well as on the basis of the following examples:

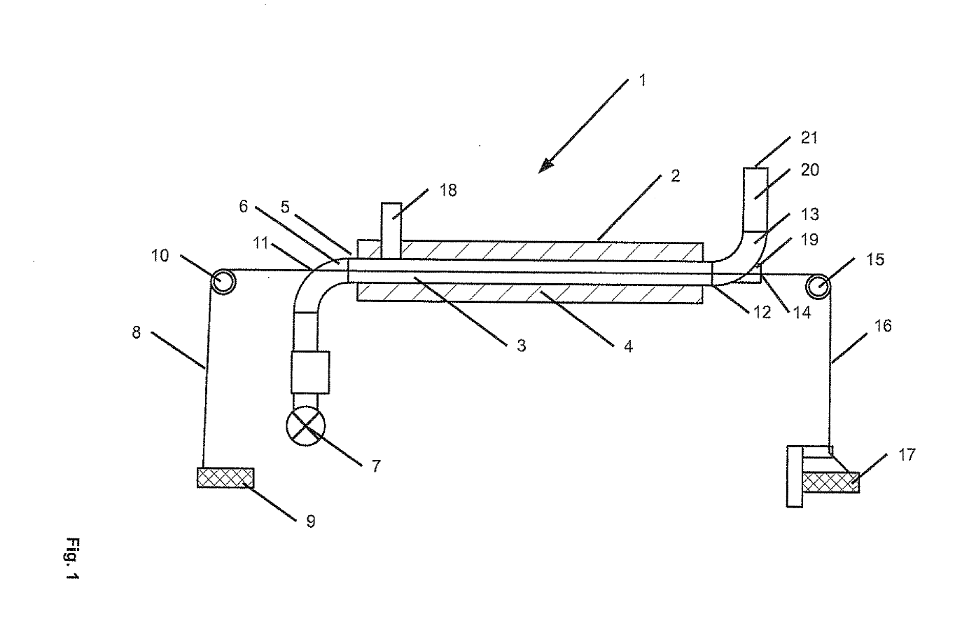

FIG. 1 shows an application device 1 as it is suitable for carrying out the method according to an embodiment of the invention. The application device 1 has an applicator 2 with an application space 3, which can be tempered to the required temperature by a heating jacket 4. At its input end 5, the applicator 2 is connected to an elbow joint or elbow pipe 6, via which the high-frequency electromagnetic waves generated in a magnetron 7 are supplied into the application space 3.

The polyacrylonitrile precursor yarn 8 to be stabilized is drawn off a bobbin 9, after winding around a guide roller 10 it is fed via an aperture 11 in the elbow joint 6 into the applicator 2 and conveyed through the application space 3. After passing through the application space 3, the precursor yarn 8 treated in the applicator 2 leaves the application device 1 via an elbow joint 13 connected to the outlet end 12 of the applicator 2 through an aperture 14. After winding around a further guide roller 15, the treated, i.e. the at least partially stabilized yarn 16 is wound on a bobbin 17. The thread tension of the precursor yarn can be set by the drive speed of the guide rollers 10, 15.

The process gas required in embodiments is supplied into the application space 3 via an inlet nozzle 18 and, in the embodiment shown, is conveyed through the application space 3 in co-current flow to the precursor yarn 8. The process gas, together with the volatile decomposition products, which are generated as a result of the conversion reactions proceeding in the yarn 8 in the application space 3, is discharged from the applicator 2 via an outlet nozzle 19 located at the elbow joint 13.

The elbow joint 13 at the outlet end 12 of the applicator 2 is, in the case shown, connected to a pipe section 20, which is closed at its free end by a metal plate 21. By this means it is achieved that the electromagnetic waves are reflected back into the application space 3.

### EXAMPLES

### Example 1

An untreated precursor yarn made from polyacrylonitrile was provided, as is suitable for producing carbon fibers, wherein the precursor yarn had 12,000 filaments with a filament diameter of approximately 8 μm. The density of the precursor yarn was 1.18 g/cm³.

The application device used for the microwave treatment corresponded in construction to the device shown in FIG. 1. Microwaves with a wavelength of 2.45 GHz were generated in a microwave generator and fed via a rectangular waveguide connected to the microwave generator via an elbow joint into the application space (rectangular waveguide type R 26), which had a length of 120 cm. Hot air with a temperature of 190° C. was supplied into the rectangular waveguide via a laterally located nozzle and fed through the application space in co-current flow to the precursor yarn, wherein the volume flow was dimensioned in such a way that there resulted an average flow rate of 2 m/s in the application space. The application space was tempered to a temperature of 170° C. by heating elements located in the wall, so that in the application space an air temperature of 170° C. prevailed. In the application space, a maximum electrical field strength of 30 kV/m was set.

In the area of the elbow joint, the polyacrylonitrile precursor yarn was fed into the application device and conveyed continuously through the applicator at a speed of 30 m/h and at a thread tension of 0.9 cN/tex. In the area of the elbow joint connected to the outlet of the applicator, the yarn was drawn out of the application device.

Already after a residence time of 2.4 min, progress concerning the yarn stabilization could be determined based on a clearly recognizable yellow coloring of the yarn. The density of the yarn had increased to 1.19 g/cm³.

### Example 2

The same application device as in Example 1 was used. The method parameters were also the same as in Example 1. Instead of the untreated precursor yarn, however, a polyacrylonitrile precursor yarn was provided which had already been subjected to a partial stabilization in a conventional process in a convection oven. The yarn provided in this example had a density of 1.19 g/cm³ and a yellow coloration.

After having passed through the application device, the density of the yarn had increased to 1.20 g/cm³ and the yarn had assumed a dark brown color.

### Example 3

The same application device was used as in Example 1, wherein the applicator, however, unlike Example 1 had a length of 1 m. A partially stabilized yarn was provided as the precursor yarn, which had a density of 1.21 g/cm³ and a dark brown to black color due to the partial stabilization. Departing from the process conditions of Example 1, the temperature of the hot air supplied and the temperature of the heating elements located in the wall of the applicator were set to 170° C., so that the hot air in the application space likewise had a temperature of 170° C. The thread speed was 10 m/h, the thread tension 1.25 cN/tex.

A pulsing microwave field was set in the application space by switching the magnetron on and off, for which field strength the maximum electrical field strength pulsed at 25 kV/m (15 s) and at 0 kV/m (6 s).

Already after a single passage, i.e. after a residence time of approximately 6 min, the color of the yarn leaving the application device had changed in the direction of a black coloration. The density had increased to 1.24 g/cm³.

### Example 4

An application device was used as in Example 1, wherein also the same process parameters as in Example 1 were set. The yarn used as the precursor yarn was the same as that used in Example 1. Departing from Example 1, however, the yarn was treated in the application device multiple times consecutively, in that it was fed through the application device a total of three times. The partially stabilized precursor yarn of the previous passage through the application device served thereby as the feed for the subsequent passage.

The total residence time in the application device was 7.5 min. The precursor yarns treated three times had a density of 1.22 g/cm³. The originally white precursor yarn had a dark brown to black color after the treatment.

### Example 5

The same process was used in Example 5 as in Example 3, however the maximum electrical field strength was set to a constant value of 30 kV/m. The yarn provided in this example was a partially stabilized polyacrylonitrile precursor yarn with a density of 1.26 g/cm³. After being conveyed through the application device, i.e. after a residence time of 6 min at a thread speed of 10 m/h, the treated yarn had a density of 1.4 g/cm³.

### Comparative Example 1

A non-stabilized precursor yarn, such as had been provided in Example 1, was subjected to a stabilization process in a conventional, multi-step convection oven for stabilizing polyacrylonitrile precursor yarns for producing carbon fibers. Air was channeled through the convection oven. In the first step of the oven, the temperature was set to approximately 230° C.

After a residence time of 23 min, the partially stabilized precursor yarn left the first step of the oven. The partially stabilized precursor yarn had a dark brown to black color and a density of 1.21 g/cm³.

1. A method for stabilizing yarns made from polyacrylonitrile using chemical stabilization reactions, comprising:
generating a field of high-frequency electromagnetic waves in an application space of an applicator, which has areas with minimum electric field strength and areas with maximum electric field strength, the maximum electric field strength in the application space being in a range from 3 to 150 kV/m;
continuously supplying a precursor yarn based on a polyacrylonitrile polymer into the application space and conveying the precursor yarn through the application space and through the field of the high-frequency electromagnetic waves; and
introducing a process gas into the application space and conveying the process gas through the application space with a flow rate of at least 0.1 m/s relative to the precursor yarn being conveyed through the application space,
wherein a temperature of the process gas is in a range between 150 and 300° C., so that it is above a critical minimum temperature T_{crit} and below a maximum temperature Tₘₐₓ, the critical minimum temperature T_{crit} being a temperature above which the high-frequency electromagnetic waves couple into the precursor yarn being conveyed through the application space and the chemical stabilization reactions proceed, and the maximum temperature Tₘₐₓ being a temperature that lies 20° C. below a decomposition temperature of the precursor yarn being supplied into the application space.

2. The method according to claim 1, wherein the maximum electric field strength of the high-frequency electromagnetic waves generated in the application space is from 5 to 50 kV/m.

3. The method according to claim 1, wherein the precursor yarn is conveyed through the applicator at a thread tension in a range from 0.125 to 5 cN/tex.

4. The method according to claim 1, wherein the process gas is conveyed through the application space vertically to the precursor yarn at a flow rate of 0.1 to 2 m/s.

5. The method according to claim 1, wherein the process gas is conveyed through the application space parallel to the precursor yarn at an average flow rate, in relation to the open cross-section of the application space, of 0.1 to 20 m/s relative to the precursor yarn being conveyed through the application space.

6. The method according to claim 1, wherein the process gas is a gas containing oxygen.

7. The method according to claim 6, wherein the gas containing oxygen is air.

8. The method according to claim 1, wherein the precursor yarn contains an additive to improve the absorption capability of the precursor yarn with regard to the high-frequency electromagnetic waves.

9. The method according to claim 8, wherein the additive is polyethylene glycol, carbon black, or carbon nanotubes.

10. The method according to claim 1, wherein the high-frequency electromagnetic waves are microwaves with a frequency in a range of 0.3 to 45 GHz.

11. The method according to claim 1, wherein a residence time of the precursor yarn in the application space is at least 20 s.

12. The method according to claim 1, wherein the process gas in the application space has a temperature in a range between (T_{crit}+20° C.) and (Tₘₐₓ−20° C.).

13. The method according to claim 1, wherein the field strength in the application space has a periodically changing intensity over time.

14. The method according to claim 1, wherein the precursor yarn is conveyed through at least two application devices arranged in series.
